(19) United States
(12) Patent Application Publication
(10) Pub. No.: US 2026/0188586 A1
(43) Pub. Date: Jul. 2, 2026

(54) MULTILAYER ELECTRONIC COMPONENT

(71) Applicant: SAMSUNG ELECTRO-MECHANICS CO., LTD., Suwon-si (KR)

(72) Inventors: Chae Min Park, Suwon-si (KR); Yoo Jeong Lee, Suwon-si (KR); So Eun Choi, Suwon-si (KR); Yong Won Seo, Suwon-si (KR); So Jung An, Suwon-si (KR); Jung Won Park, Suwon-si (KR); Jong Ho Lee, Suwon-si (KR)

(73) Assignee: SAMSUNG ELECTRO-MECHANICS CO., LTD., Suwon-si (KR)

(21) Appl. No.: 19/364,717

(22) Filed: Oct. 21, 2025

(30) Foreign Application Priority Data
Dec. 27, 2024 (KR) 10-2024-0198405
Mar. 26, 2025 (KR) 10-2025-0038783

(51) Int. Cl. H01G 4/232; H01G 4/30

(52) U.S. Cl. CPC H01G 4/2325; H01G 4/30

(57) ABSTRACT

A multilayer electronic component according to an embodiment of the present disclosure may comprises: a body including a dielectric layer and an internal electrode; and an external electrode disposed on the body; wherein the external electrode includes a Ni plating layer, and the Ni plating layer may have a Texture Coefficient (TC) value such that TC(200) is the greatest among TC(111), TC(200), and TC(220).

### CROSS-REFERENCE TO RELATED APPLICATION(S)

This application claims the benefit of priority to Korean Patent Application No. 10-2024-0198405 filed on Dec. 27, 2024 and Korean Patent Application No. 10-2025-0038783 filed on Mar. 26, 2025 in the Korean Intellectual Property Office, the disclosure of which is incorporated herein by reference in its entirety.

### TECHNICAL FIELD

The present disclosure relates to a multilayer electronic component.

### BACKGROUND

A multilayer ceramic capacitor (MLCC), a multilayer electronic component, is a chip-type condenser, mounted on the printed circuit boards of various types of electronic product, such as image display devices, including a liquid crystal display LCD and a plasma display panel PDP, computers, smartphones and mobile phones, and serves to charge or discharge electricity therein or therefrom.

The multilayer ceramic capacitor may be used as a component of various electronic devices, since a multilayer ceramic capacitor may have a small size and high capacitance and may be easily mounted.

Recently, with the implementation of miniaturization and high performance in electronic devices, multilayer ceramic capacitors have also been trending toward being miniaturized and having higher capacitance, and the importance of ensuring high reliability of multilayer ceramic capacitors is increasing.

In general, to improve mountability of an MLCC, the external electrodes thereof may include plating layers, however, there has been concern that reliability of the MLCC could be reduced in the case that hydrogen generated during the plating process to form the plating layer, or hydrogen existing externally, diffuses into the body.

### DISCLOSURE OF INVENTION

An aspect of the present disclosure is to provide a multilayer electronic component having excellent reliability.

An aspect of the present disclosure is to provide the multilayer electronic component capable of suppressing hydrogen diffusion.

However, problems to be solved by the present disclosure are not limited to the above, and will be more easily understood in the process of describing specific embodiments of the present disclosure.

A multilayer electronic component according to an embodiment of the present disclosure may comprise: a body including a dielectric layer and an internal electrode; and an external electrode disposed on the body; wherein the external electrode may include a Ni plating layer, and the Ni plating layer may have a Texture Coefficient TC such that TC(200) is the greatest among TC(111), TC(200), and TC(220).

The multilayer electronic component according to an embodiment of the present disclosure may comprise: a body including dielectric layers and internal electrodes alternately disposed with the dielectric layers; and external electrodes including base electrode layers disposed on the body and connected to the internal electrodes; wherein the base electrode layers may include Al, Cu, and glass. According to an aspect of the present disclosure, the reliability of a multilayer electronic component may be improved.

According to an aspect of the present disclosure, deterioration of insulation resistance of the multilayer electronic component may be suppressed.

According to an aspect of the present disclosure, the multilayer electronic component capable of suppressing hydrogen diffusion into the body may be provided.

However, various and beneficial advantages and effects of the present disclosure are not limited to the above, and may be more easily understood in the process of describing specific embodiments of the present disclosure.

### BRIEF DESCRIPTION OF DRAWINGS

FIG. 1 is a perspective view schematically illustrating a multilayer electronic component according to an embodiment of the present disclosure.

FIG. 2 schematically illustrates a cross-sectional view taken along line I-I′ of FIG. 1.

FIG. 3 schematically illustrates a cross-sectional view taken along line II-II′ of FIG. 1.

FIG. 4 schematically illustrates a disassembled body.

FIG. 5 is an X-ray diffraction (XRD) analysis graph for test numbers 1 to 3.

FIG. 6 is a graph illustrating TC values for test numbers 1 to 4.

FIG. 7 is a graph illustrating TC values for test numbers 5 to 9.

FIGS. 8A-8C are graphs illustrating an insulation resistance IR measured for test numbers 1 to 3.

FIG. 9 is a drawing corresponding to FIG. 2 according to another embodiment of the present disclosure.

### DESCRIPTION OF REFERENCE CHARACTERS

Hereinafter, embodiments of the present disclosure will be described with reference to specific embodiments and the accompanying drawings. However, embodiments of the present disclosure may be modified into various other forms, and the scope of the present disclosure is not limited to the embodiments described below. Further, embodiments of the present disclosure may be provided for a more complete description of the present disclosure to the ordinary artisan. Therefore, shapes and sizes of the elements in the drawings may be exaggerated for clarity of description, and the elements denoted by the same reference numerals in the drawings may be the same elements.

In the drawings, portions not related to the description will be omitted for clarification of the present disclosure, and a thickness may be enlarged to clearly illustrate layers and regions. The same reference numerals will be used to designate the same components with the same reference numerals. Further, throughout the specification, when an element is referred to as “comprising” or “including” an element, it means that the element may further include other elements as well, without departing from the other elements, unless specifically stated otherwise.

In the drawing, an X-direction may be defined as a first direction, a stacking direction or a thickness T direction, a Y-direction may be defined as a second direction or a length L direction, and a Z-direction may be defined as a third direction or a width W direction.

### Multilayer Electronic Component

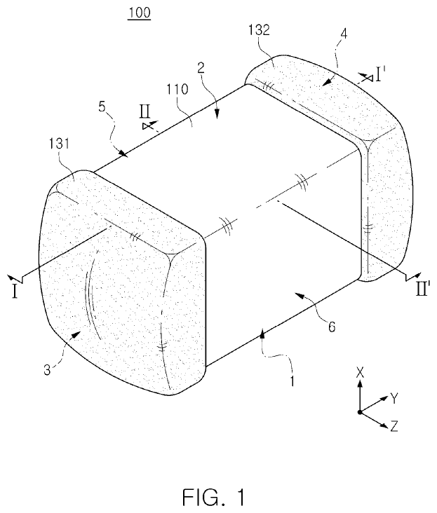

FIG. 1 is a perspective view schematically illustrating a multilayer electronic component according to an embodiment of the present disclosure.

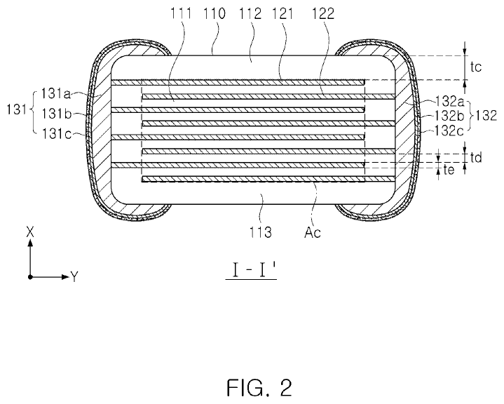

FIG. 2 schematically illustrates a cross-sectional view taken along line I-I′ of FIG. 1.

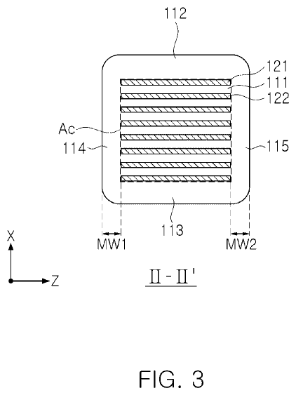

FIG. 3 schematically illustrates a cross-sectional view taken along line II-II′ of FIG. 1.

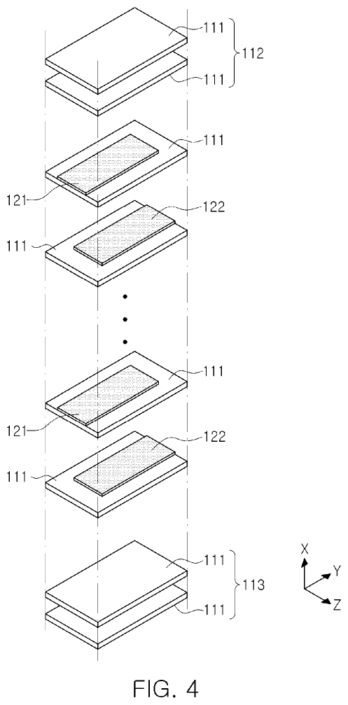

FIG. 4 schematically illustrates a disassembled body.

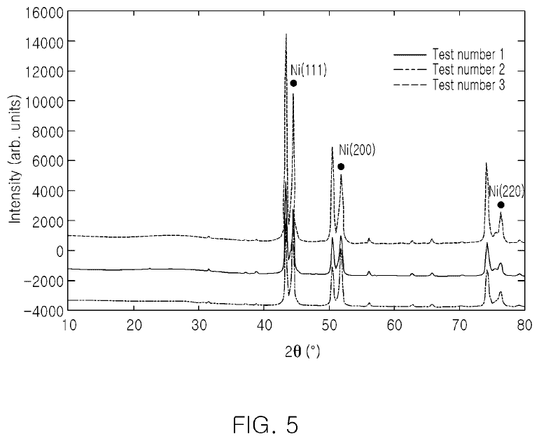

FIG. 5 is an X-ray diffraction (XRD) analysis graph for test numbers 1 to 3.

Hereinafter, a multilayer electronic component 100 according to an embodiment of the present disclosure will be described in detail with reference to FIGS. 1 to 5. In addition, as an example of a multilayer electronic component, a multi-layered ceramic capacitor (hereinafter referred to as “MLCC”) is described, but the present disclosure is not limited thereto and may also be applied to various multilayer electronic components using ceramic materials, such as inductors, piezoelectric elements, varistors, or thermistors.

The multilayer electronic component 100 according to an embodiment of the present disclosure comprises: a body 110 including a dielectric layer 111 and internal electrodes 121 and 122; and external electrodes 131 and 132 disposed on the body, wherein the external electrodes include Ni plating layers 131b and 132b, and the Ni plating layers may have a Texture Coefficient TC such that TC(200) is the greatest among TC(111), TC(200), and TC(220).

In general, in order to improve the mountability of the MLCC, the external electrode may include a plating layer, and there was a concern that the reliability of the MLCC could be reduced when hydrogen generated during the plating process to form the plating layer or hydrogen existing externally diffuses into the body.

Hydrogen generated during formation of the Ni plating layer is a common byproduct in the electro-plating process, and when it diffuses into the body, it may cause a deterioration in insulation resistance, which may lead to failure.

In the case of the Ni plating layer, the diffusion anisotropy of hydrogen may be greater depending on the crystallographic characteristics. Accordingly, in an embodiment of the present disclosure, by controlling the Texture Coefficient TC value of the Ni plating layers 131b and 132b such that TC(200) is the greatest among TC(111), TC(200), and TC(220), it may be possible to suppress hydrogen generated during the plating process and hydrogen penetration due to the external environment.

Hereinafter, each component included in the multilayer electronic component 100 according to an embodiment of the present disclosure will be described.

The body 110 may have the dielectric layers 111 and the internal electrodes 121 and 122 alternately stacked therein.

The body 110 is not limited to a particular shape, and may have a hexahedral shape or a shape similar to the hexahedral shape, as illustrated in the drawings. The body 110 may not have a hexahedral shape having perfectly straight lines because ceramic powder particles included in the body 110 may contract in a process in which the body is sintered. However, the body 110 may have a substantially hexahedral shape.

The body 110 may have first and second surfaces 1 and 2 opposing each other in a thickness direction (X-direction), third and fourth surfaces 3 and 4 connected to the first and second surfaces 1 and 2 and opposing each other in a length direction (Y-direction), and fifth and sixth surfaces 5 and 6 connected to the first and second surfaces 1 and 2, connected to the third and fourth surfaces 3 and 4, and opposing each other in a width direction (Z-direction).

As a margin region where the internal electrodes 121 and 122 are not be disposed on the dielectric layer 111, overlaps, a step difference may occur due to the thickness of the internal electrodes 121 and 122, a corner connecting the first surface and the third to fifth surfaces and/or the corner connecting the second surface and the third to fifth surfaces may have a contracted form toward the center of the body 110 in the thickness direction when viewed based on the first surface or the second surface. Alternatively, due to the contraction behavior during a sintering process of the body, a corner connecting the first surface 1 and the third to sixth surfaces 3, 4, 5, and 6 and/or a corner connecting the second surface 2 and the third to sixth surfaces 3, 4, 5, and 6 may have a form contracting toward the center of the body 110 in the thickness direction when viewed based on the first surface or the second surface. Alternatively, to prevent chipping defects, or the like, the corners connecting each surface of the body 110 may be rounded by performing an additional process, in which the corners connecting the first surface and the third to sixth surfaces and/or the corners connecting the second surface and the third to sixth surfaces may have a round form.

Meanwhile, in order to suppress the step difference caused by the internal electrodes 121 and 122, after stacking, the internal electrodes are cut so that they are exposed to the fifth and sixth surfaces 5 and 6 of the body, and then when a single dielectric layer or two or more dielectric layers are stacked in the width direction on both surfaces of a capacitance formation portion Ac to form the margin portions 114 and 115, a portion connecting the first surface and the fifth and sixth surfaces and a portion connecting the second surface and the fifth and sixth surfaces may not have a contracted form.

A plurality of dielectric layers 111 forming the body 110 may be in a sintered state, and adjacent dielectric layers 111 may be integrated with each other, such that boundaries therebetween may not be readily apparent without a scanning electron microscope SEM. The number of dielectric layers is not particularly limited and it may be determined in consideration of a size of the multilayer electronic component. For example, a body may be formed by stacking more than 400 layers of genetic layers.

The dielectric layer 111 may be formed by preparing a ceramic slurry containing ceramic powder, an organic solvent, and a binder, applying and drying the slurry on a carrier film to prepare a ceramic green sheet, and then sintering the ceramic green sheet. The ceramic powder is not particularly limited as long as sufficient electrostatic capacitance may be obtained, but for example, barium titanate (BaTiO₃)-based powder may be used as the ceramic powder. For a more specific example, the ceramic powder may be one or more of BaTiO₃, (Ba₁₋ₓCaₓ)TiO₃ (0<x<1), Ba(Ti_{1-y}Ca_{y})O₃ (0<y<1), (Ba₁₋ₓCaₓ) (Ti_{1-y}Zr_{y})O₃ (0<x<1, 0<y<1) and Ba(Ti_{1-y}Zr_{y}) O₃ (0<y<1).

An average thickness td of the dielectric layer 111 is not particularly limited, but may be, for example, 0.01 μm to 10 μm. Additionally, the average thickness td of the dielectric layer 111 may be arbitrarily set according to desired characteristics or purpose, and for example, in the case of small IT electronic components, in order to achieve miniaturization and high capacitance, the average thickness td of at least one of the plurality of dielectric layers 111 may be 1.5 μm or less.

In this case, the average thickness td of the dielectric layer 111 may refer to a size of the dielectric layer 111 disposed between the internal electrodes 121 and 122 in the X-direction (thickness direction). The average thickness of the dielectric layer 111 may be measured by scanning cross-sections (L-T cross-sections) of the body 110 in the length and thickness direction with a scanning electron microscope SEM of 10,000× magnification. More specifically, the thickness at a plurality of points of one dielectric layer 111, for example, at 30 points equally spaced apart from each other in the length direction, and then taking the average value. The 30 points which are equally spaced apart, may be designated in the capacitance formation portion Ac to be described later. In addition, when measuring the average value measurements is expanded to 10 dielectric layers 111 to calculate the average value, the average thickness of the dielectric layer 111 may be further generalized.

The body 110 may include the capacitance formation portion Ac, in which capacitance is formed by a first internal electrode 121 and a second internal electrode 122 disposed inside the body 110 and may be disposed to face each other with the dielectric layer 111 interposed therebetween, and cover portions 112 and 113 formed upper and lower portions of the capacitance formation portion Ac in the first direction.

In addition, the capacitance formation portion Ac may be a portion contributing to a capacitance formation of the capacitor, and may be formed by repeatedly stacking a plurality of first and second internal electrodes 121 and 122 with the dielectric layer 111 therebetween.

The cover portions 112 and 113 may include an upper cover portion 112 disposed on an upper portion of the capacitance formation portion Ac in the X-direction and a lower cover portion 113 disposed on a lower portion of the capacitance formation portion Ac in the X-direction.

The upper cover portion 112 and the lower cover portion 113 may be formed by stacking a single dielectric layer or two or more dielectric layers on upper and lower surfaces of the capacitance formation portion Ac in the thickness direction, respectively, and the upper cover portion 112 and the lower cover portion 113 may contribute to basically prevent damage to the internal electrodes due to physical or chemical stress.

The upper cover portion 112 and the lower cover portion 113 may not include the internal electrodes, and may include the same material as that of the dielectric layer 111.

That is, the upper cover portion 112 and the lower cover portion 113 may include a ceramic material, for example, a barium titanate (BaTiO₃)-based ceramic material.

Meanwhile, a thickness of the cover portions 112 and 113 is not particularly limited. However, in order to more easily achieve miniaturization and high capacitance of the multilayer electronic component, the thickness tc of the cover portions 112 and 113 may be 60 μm or less.

The average thickness tc of the cover portions 112 and 113 may refer to a size in the X-direction, and may be an average value of a size of the cover portions 112 and 113 in the X-direction measured at 5 equally spaced apart points on the upper or lower portions of the capacitance formation portion Ac.

In addition, margin portions 114 and 115 may be disposed on a side surface of the capacitance formation portion Ac.

The margin portions 114 and 115 may include a first margin portion 114 disposed on the fifth surface 5 of the body 110 and a second margin portion 115 disposed on the sixth surface 6 thereof. That is, the margin portions 114 and 115 may be disposed on both end surfaces of the ceramic body 110 in the width direction.

As illustrated in FIG. 3, the margin portions 114 and 115 may refer to a region between two ends of the first and second internal electrodes 121 and 122 and a boundary surface of the body 110 in a cross-section of the body 110 in a width-thickness (W-T) direction.

The margin portions 114 and 115 may basically contribute to prevent damage to the internal electrodes due to physical or chemical stresses.

The margin portions 114 and 115 may be formed by forming an internal electrodes by applying a conductive paste to the ceramic green sheet, except for a region where the margin portion is to be formed.

In addition, to suppress a step difference caused by the internal electrodes 121 and 122, after stacking, the internal electrodes may be cut so that they are exposed to the fifth and sixth surfaces 5 and 6 of the body, and then a single dielectric layer or two or more dielectric layers may be stacked in the Z-direction (width direction) on both surfaces of the capacitance formation portion Ac to form the margin portions 114 and 115.

Meanwhile, a width of the margin portions 114 and 115 is not particularly limited. However, in order to more easily achieve miniaturization and high capacitance of the multilayer electronic component, an average width of the margin portions 114 and 115 may be 45 μm or less.

The average width of the margin portions 114 and 115 may refer to an average size of a region where the internal electrode is spaced apart from the fifth surface in the Z-direction and an average size of a region where the internal electrode is spaced apart from the sixth surface in the Z-direction, and may be an average value of a size of the margin portions 114 and 115 in the Z-direction measured at 5 points equally spaced apart on the side surface of the capacitance formation portion Ac.

Accordingly, in an embodiment, average sizes MW1 and MW2 of the regions spaced apart from the fifth and sixth surfaces of the internal electrodes 121 and 122 in the third direction, may be 45 μm or less, respectively.

Meanwhile, when a magnetic material is applied instead of a dielectric material to the body 110, the multilayer electronic component may function as an inductor. The magnetic material may be, for example, ferrite and/or metal magnetic particles. When the multilayer electronic component functions as an inductor, the internal electrodes may be coil-shaped conductors.

In addition, when a piezoelectric material is applied instead of the dielectric material to the body 110, the multilayer electronic component may function as a piezoelectric element. The piezoelectric material may be, for example, Lead Zirconate Titanate PZT.

In addition, when a ZnO-based or Sic-based material is applied to the body 110 instead of the dielectric material, the multilayer electronic component may function as a varistor, and when a spinel-based material is applied to the body 110 instead of the dielectric material, the multilayer electronic component may function as a thermistor.

That is, the multilayer electronic component 100 according to an embodiment of the present disclosure may function as an inductor, a piezoelectric element, a varistor, or a thermistor as well as a multilayer ceramic capacitor by appropriately changing the material or structure of the body 110.

The internal electrodes 121 and 122 may be alternately disposed with the dielectric layer 111, and for example, a pair of electrodes having different polarities, such as the first internal electrode 121 and the second internal electrode 122, may be disposed to face each other with the dielectric layer 111 interposed therebetween. The first internal electrode 121 and the second internal electrode 122 may be electrically separated from each other by a dielectric layer 111 disposed therebetween. In this case, the internal electrodes 121 and 122 may be alternately disposed with the dielectric layer 111 in the X-direction.

The first internal electrode 121 may be spaced apart from the fourth surface 4, but may extend toward the third surface 3. The second internal electrode 122 may be spaced apart from the third surface 3, but may extend toward the fourth surface 4. The first internal electrode 121 may be electrically connected to the first external electrode 131 at the third surface 3, and the second internal electrode 122 may be electrically connected to the second external electrode 132 at the fourth surface 4.

The conductive metal included in the internal electrodes 121 and 122 may be one or more of Ni, Cu, Pd, Ag, Au, Pt, Sn, W, Ti, and alloys thereof. For example, the internal electrodes 121 and 122 may include Ni as a main component may mean that, and in this case, including Ni as a main component may mean that, when the cross-section of the internal electrode is analyzed by SEM-EDS, the area ratio occupied by Ni compared to the entire area of the internal electrode is 90% or greater.

A method for forming the internal electrodes 121 and 122 is not particularly limited. For example, the internal electrodes 121 and 122 may be formed by applying sintering a conductive paste for internal electrodes containing conductive metal on the ceramic green sheet. An application method for the conductive paste for the internal electrodes may use a screen printing method or a gravure printing method, but the present disclosure is not limited thereto.

An average thickness the of the internal electrodes 121 and 122 is not particularly limited, but may be, for example, 0.01 μm to 3 μm. Additionally, the average thickness the of the internal electrodes 121 and 122 may be arbitrarily set according to desired characteristics or purpose, and for example, in the case of small IT electronic components, in order to achieve miniaturization and high capacitance, the average thickness the of at least one of the plurality of internal electrodes 121 and 122 may be 0.8 μm or less.

In this case, the average thickness the of the internal electrodes may be measured by scanning the cross-sections (L-T cross-sections) of the body 110 in the length and thickness direction with a scanning electron microscope SEM of 10,000× magnification. More specifically, the average value may be measured by calculating the thickness at a plurality of points of one internal electrodes 121 and 122, for example, 30 points equally spaced apart from each other in the Y-direction, and then taking the average value. The 30 points which are equally spaced apart, may be designated in the capacitance formation portion Ac. Additionally, when measuring the average value measurement expanded to 10 internal electrodes 121 and 122, the average value of the internal electrodes 121 and 122 may be further generalized.

External electrodes 131 and 132 may be disposed on the body 110.

As illustrated in FIG. 2, the external electrodes 131 and 132 may include the first external electrode 131 disposed on the third surface of the body 110 and connected to the first internal electrode 121, and the second external electrode 132 disposed on the fourth surface 4 of the body 110 and connected to the second internal electrode 122.

embodiment, a structure in which the multilayer electronic component 100 has two external electrodes 131 and 132 is described, but the number or shape of the external electrodes 131 and 132 may be changed depending on a shape of the internal electrodes 121 and 122 or other purposes.

The external electrodes 131 and 132 may include Ni plating layers 131b and 132b, and the Ni plating layer may have a Texture Coefficient TC such that TC(200) is the greatest among TC(111), TC(200), and TC(220).

In the case of the Ni plating layer, diffusion anisotropy of hydrogen may be significant depending on its crystallographic characteristics, and when TC(200) is the greatest among the TC 111, TC 200, and TC 220, the Ni plating layer may contribute as a hydrogen barrier, thereby suppressing the diffusion of hydrogen.

The Texture Coefficient TC value of the Ni plating layer is an important indicators used in materials science and surface engineering to evaluate a crystal structure and orientation of the plating layer. TC may be measured through analysis, and may numerically X-ray diffraction XRD represent how predominantly a specific crystal plane (hk1) is oriented in the plating layer. In other words, TC quantifies the preferred orientation of crystallites in a polycrystalline material. TC may be used to understand the structural characteristics and physical properties of the plating layer. TC of 1 indicates a random orientation while TC of greater than 1 indicates a higher degree of orientation along that particular plane.

For the Ni plating layer, it generally may have a face-centered cubic FCC structure, and the major diffraction planes of the face-centered cubic FCC structure may be 111 plane, 200 plane, and 220 plane. Accordingly, among the TC(111), TC(200), and TC(220), the fact that the TC(200) is the greatest may mean that the 200 plane is the most predominantly oriented among the major diffraction planes.

Meanwhile, Texture Coefficient may be calculated by the following Equation 1.

$$TC ( hkl ) = \frac{\frac{I ( hkl )}{{I}_{0} ( hkl )}}{\frac{1}{N} {\sum }_{hkl} \frac{I ( hkl )}{{I}_{0} ( hkl )}} \qquad [ Equation 1 ]$$

In the Equation 1, TC(hk1) refers to a Texture Coefficient of a corresponding crystal plane (hk1), I(hk1) refers to a diffraction peak intensity of a corresponding crystal plane (hk1) in a measured XRD data, and I₀(hk1) refers to a diffraction peak intensity of a corresponding crystal plane (hk1) in a standard JCPDS data.

In addition, in the Equation 1, N refers to a total number of diffraction planes considered, and Σ(I(hk1) I₀(hk1)) refers to the sum of relative intensities of all (hk1) planes.

First, a diffraction pattern is obtained through XRD analysis of the Ni plating layer. From the XRD data, the intensities I(hk1) at various diffraction planes (Miller indices, e.g. (111), (200), and (220)), may be obtained. This indicates the degree to which the crystal structure within the plating layer is disposed in a specific direction.

Afterwards, the intensity value I₀(hk1) for the same diffraction plane may be confirmed from the standard data of Ni standard powder provided by the International Centre for Diffraction Data ICDD.

Afterwards, sum of relative intensities calculated for all diffraction planes is obtained, and then an average value is calculated by dividing the sum by the total number N of diffraction planes. The average value refers to an average crystal strength of an entirety of samples.

Finally, the Texture Coefficient for each diffraction plane may be calculated by the Equation 1.

When the calculated value of TC(hk1) is greater than 1, it may mean that texture is formed in the corresponding (hk1) direction (there is preferential crystal growth). When the calculated value of TC(hk1) is 1, it may mean that it has an ideal random distribution. When the calculated value of TC(hk1) is less than 1, it may mean that less crystal growth achieved in the corresponding direction.

Meanwhile, the Texture Coefficient TC value of the Ni plating layers 131b and 132b may be a value for the main diffraction planes of the Ni plating layers 131b and 132b, such as 111 plane, 200 plane, and 220 plane.

That is, the TC(111), TC(200) and TC(220) may satisfy
TC(111)={I(111)/I₀(111)}/[⅓*{I(111)/I₀(111)+I(200)/I₀(200)+I(220)/I₀(220)}],
TC(200)={I(200)/I₀(200)}/[⅓*{I(111)/I₀(111)+I(200)/I₀(200)+I(220)/I₀(220)}], and
TC(220)={I(220)/I₀(220)}/[⅓ *{I(111)/I₀(111)+I(200)/I₀(200)+I(220)/I. (220)}], wherein I(111), I(200) and I(220) are diffraction peak intensities of the 111 plane, 200 plane and 220 plane, respectively, obtained from the XRD analysis data of the Ni plating layer, and I₀(111), I₀(200), and I₀(220) may respectively refer to the diffraction peak intensities of the 111 plane, 200 plane and 220 plane of standard Ni powder provided by the International Centre for Diffraction Data ICDD.

Meanwhile, each of the values for the TC(111), TC(200) and TC(220) of the Ni plating layers 131b and 132b may vary depending on the number of analyzed diffraction planes, and when TC(220) is the greatest among the TC(111), TC(200) and TC(220) of the Ni plating layers 131b and 132b, the Ni plating layer may function as a hydrogen barrier to suppress hydrogen diffusion, accordingly, it is not necessary to particularly limit the values of TC(111), TC(200) and TC(220).

For example, when the Texture Coefficient TC value of the Ni plating layers 131b and 132b may be a value for major diffraction planes of the Ni plating layers 131b and 132b, such as the 111 plane, 200 plane, and 220 plane, and the TC(200) may be 1.2 or greater. Accordingly, the hydrogen diffusion suppression effect according to the present disclosure may be further improved.

In this case, the TC(220) may be 1.0 or less.

In addition, the TC(111) may be 0.5 or greater compared to the TC(220).

Meanwhile, when (200) Factor=TC(200)/[{TC(111)+TC(220)}/2] is satisfied, the Ni plating layer may have a (200) Factor greater than 1. The (200) Factor refers to a value corresponding to TC(200) compared to an average value of TC(111) and TC(220), and when the (200) Factor exceeds 1.0, the hydrogen diffusion suppression effect of the Ni plating layer may be further improved.

In addition, as the (200) Factor increases, the hydrogen suppression inhibition effect may be improved. In an embodiment, the Ni plating layers 131b and 132b may have a (200) Factor of 1.3 or greater. Accordingly, the hydrogen diffusion suppression effect of the Ni plating layers 131b and 132b may be further improved. Therefore, it may be more preferable for the Ni plating layers 131b and 132b to have a (200) Factor of 1.3 or greater, and more preferably, the Ni plating layers 131b and 132b may have a (200) Factor of 1.5 or greater.

Meanwhile, a method of forming the Ni plating layers 131b and 132b is not particularly limited. For example, it may be formed by using an electro-plating method. Additionally, a controlling the Texture method for Coefficient TC value of the Ni plating layers 131b and 132b is not particularly limited, and for example, by controlling current density among various process conditions of electrolytic plating, TC(200) may be controlled to be the greatest among the TC(111), TC(200), and TC(220).

In an embodiment, the Ni plating layer may have a Face-Centered Cubic FCC structure. Since the Ni plating layer has the Face-Centered Cubic FCC structure, it may be clearly distinguished from NiO, which has a cubic structure.

A crystal structure of the Ni plating layer may be confirmed by XRD analysis, and when peaks are detected at diffraction angles (2θ) of 44.441°, 51.784°, and 76.276° based on Cu Kα radiation, it may be confirmed that the structure is Face-Centered Cubic FCC structure. However, NiO has the cubic structure, and peaks may be detected at diffraction angles (2θ) of 37°, 43°, and 62°.

In an embodiment, the Ni plating layer may have an atomic percentage of Ni of 95 at % or greater. This may mean that the Ni plating layer is substantially formed of Ni as formed by a plating method. Additionally, it may be clearly distinguished from NiO having an atomic percentage of O of 50 at %. The atomic percentage of Ni may be confirmed by analyzing the Ni plating layer using SEM-EDS.

In an embodiment, the external electrodes 131 and 132 may be connected to the internal electrodes 121 and 122, and may further include the electrode layers 131a and 132a disposed under the Ni plating layers 131b and 132b and an additional plating layers 131c and 132c disposed on the Ni plating layer. That is, the external electrodes 131 and 132 may be in a form of the electrode layers 131a and 132a, the Ni plating layers 131b and 132b, and the additional plating layers 131c and 132c disposed sequentially.

For a more specific example of the electrode layers 131a and 132a, the electrode layers 131a and 132a may be firing electrodes including a conductive metal and a glass, or a resin-based electrode including a conductive metal and a resin.

In addition, the electrode layers 131a and 132a may have a form in which the firing electrode and the resin-based electrode are sequentially formed on the body. Additionally, the electrode layers 131a and 132a may be formed by transferring a sheet including the conductive metal onto the body, or may be formed by transferring the sheet including the conductive metal to the fired electrode.

A material having excellent electrical conductivity may be used as the conductive metal included in the electrode layers 131a and 132a, but is not particularly limited thereto. For example, the conductive metal may be one or more of nickel (Ni), copper (Cu) and alloys thereof.

The additional plating layers 131c and 132c may contribute to improve mountability. A type of the additional plating layers 131c and 132c are not particularly limited, may be plating layers including one or more of Ni, Sn, Pd, and alloys thereof, and may be formed as a plurality of layers.

For a more specific example of the additional plating layers 131c and 132c, the additional plating layers 131c and 132c may be a Sn plating layer or a Pd plating layer, and may be formed in a structure in which a Sn plating layer, a Ni plating layer, and a Sn plating layer are sequentially formed.

A size of the multilayer electronic component 100 is not particularly limited.

However, the smaller the size of the multilayer electronic component 100, a hydrogen penetration may be easier. Particularly, when the size of the multilayer electronic component 100 is 1005 (length×width, 1.0 mm×0.5 mm) or less, it is necessary to further improve the suppression hydrogen penetration effect. Considering manufacturing tolerances, external electrode sizes, and the like, when a maximum length of the multilayer electronic component 100 is 1.1 mm or less and a maximum width is 0.55 mm or less, it is necessary to further improve the hydrogen penetration suppression effect according to the present disclosure.

Accordingly, in an embodiment, the multilayer electronic component 100 may have the maximum length of 1.1 mm or less, the maximum width of 0.55 mm or less, and the TC(200) may be 1.3 or greater. Additionally, in an embodiment, the multilayer electronic component 100 may have the maximum length of 1.1 mm or less, the maximum width of 0.55 mm or less, and when (200) Factor=TC(200)/[{TC(111)+TC(220)}/2] is satisfied, the Ni plating layer may have a (200) Factor of 1.5 or greater.

However, the hydrogen suppression effect according to the present disclosure may be effective even in large-sized chips, and the hydrogen diffusion suppression effect according to the present disclosure may be confirmed even in multilayer electronic components having a size of 1608 (length×width, 1.6 mm×0.8 mm) or greater. Accordingly, in an embodiment, a maximum length of the multilayer electronic component may be 1.44 mm or greater, and a maximum width may be 0.72 mm or greater.

Meanwhile, the Ni plating layers 131b and 132b do not necessarily need to be spaced apart from an exposed surface of the internal electrodes as illustrated in FIG. 2.

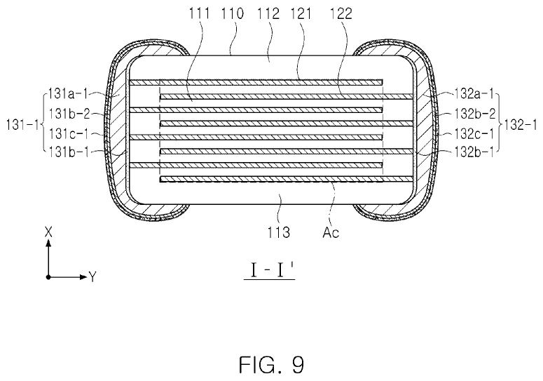

Referring to FIG. 9, a drawing corresponding to FIG. 2 according to another embodiment of the present disclosure, Ni plating layers 131b-1 and 132b-1 may be disposed to be in contact with the body 110 and may be in direct contact with the internal electrodes 121 and 122. Since the Ni plating layers 131b-1 and 132b-1 are disposed to be in contact with the body 110, the hydrogen diffusion suppression effect according to the present disclosure may be further improved.

In addition, external electrodes 131-1 and 132-1 may further include electrode layers 131a-1 and 132a-1 disposed on the Ni plating layers 131b-1 and 132b-1.

In this case, the external electrodes 131-1 and 132-1 may further include additional Ni plating layers 131b-2 and 132-2 disposed on the electrode layers 131a-1 and 132a-1. Accordingly, the hydrogen diffusion suppression effect according to the present disclosure may be further improved. In this case, the additional Ni plating layers 131b-2 and 132-2 may have the Texture Coefficient TC value such that TC(200) is the greatest among TC(111), TC(200), and TC(220).

In addition, additional plating layers 131c-1 and 132c-1 disposed on the additional Ni plating layers 131b-2 and 132-2 may be further included. The additional plating layers 131c-1 and 132c-1 may be the Sn plating layer.

### a Method for Manufacturing Multilayer Electronic Components

Hereinafter, an example of a method for manufacturing the multilayer electronic component 100 will be described. However, the manufacturing method of the multilayer electronic component 100 is not limited thereto.

First of all, the ceramic slurry containing ceramic powder, an organic solvent, and a binder is applied on a carrier film to prepare a ceramic green sheet.

Thereafter, conductive paste for an internal electrode containing metal powder, a binder, an organic solvent, or the like is printed onto the ceramic green sheet to a predetermined thickness using a screen printing method, or a gravure printing method, thereby forming an internal electrode pattern, and producing a ceramic green sheet for a capacitance formation portion.

A multilayer may be obtained by stacking the ceramic green sheets for the capacitance formation portion in the X-direction. In this case, ceramic green sheets without internal electrode patterns may be stacked on the upper and lower portions of the multilayer to form cover portions 112 and 113 after sintering.

Thereafter, the multilayer may be cut to have a predetermined chip size to obtain unit multilayer.

Thereafter, the unit multilayer may be sintered to obtain the body. The sintering temperature may be, for example, 1000° C. or greater and 1400° C. or less, but the present disclosure is not limited thereto.

Next, the external electrodes 131 and 132 may be formed. For example, when the external electrodes 131 and 132 include the electrode layers 131a and 132a, and the electrode layers 131a and 132a are sintered electrodes, the body 110 may be dipped into external electrode conductive paste for including metal powder, glass frit, a binder, and an organic solvent, and then the external electrode conductive paste may be sintered at a temperature of 500° C. to 900° C. to form the sintered electrode layers.

In addition, when the electrode layers 131a and 132a are resin electrode layers, the body may be dipped into a conductive resin composition including metal powder, a resin, a binder, and an organic solvent, and then cured and heat-treated at a temperature of 250° C. to 550° C. to form the resin electrode layers.

Thereafter, Ni plating layers 131b and 132b may be formed by using an electrolytic plating method. In this case, by adjusting current density among various process conditions of electrolytic plating, it may be possible to control TC(200) to be the greatest among TC(111), TC(200), and TC(220).

Thereafter, Sn plating layers 131c and 132c may be formed on the Ni plating layers 131b and 132b by using an electrolytic plating method.

### EXAMPLE

A sample chip of size 1005 (length: approximately 1.0 mm, width: approximately 0.5 mm, thickness: approximately 0.5 mm) was prepared by using the manufacturing method described above. In this case, when forming the Ni plating layers 131b and 132b, a current density was varied so that TC values were different as illustrated in Table 1 below.

XRD analysis was performed by obtaining a specimen of the Ni plating layer from each sample chip, the measurement conditions were [Target: Cu Kα, 2θ interval: 0.01°, 2θscan speed: 3°/min], and XRD graph as illustrated in FIG. 5 was obtained. In FIG. 5, a Y-axis represents intensity in arbitrary units, and an X-axis represents diffraction angle (2θ) in degrees.

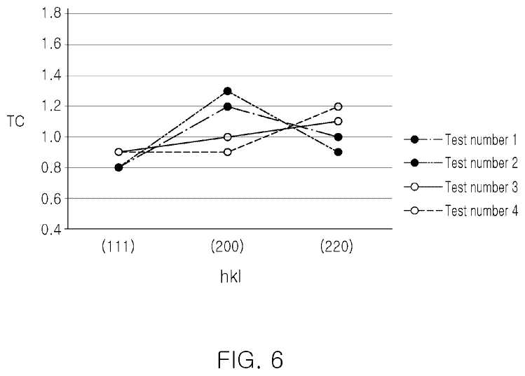

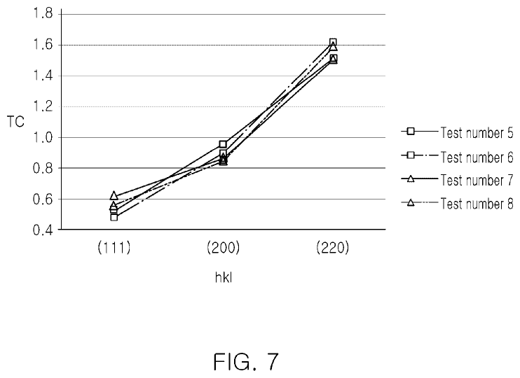

I(111), I(200), and I(220) were obtained from the XRD graph, and using I₀(111), I₀(200) and I₀(220) of the Ni standard powder provided by the International Centre for Diffraction Data ICDD, TC(111), TC(200), and TC(220) were calculated by using the Equation 1, as listed in Table 1 below, and In FIGS. 6 and 7, the TC values of each test number are illustrated as graphs.

In addition, the (200) Factor calculated as (200) Factor=TC(200)/[{TC(111)+TC(220)}/2] is listed in Table 1 below.

TABLE 1

| Test | | | | |
|---|---|---|---|---|
| No. | TC(111) | TC(200) | TC(220) | (200)Factor |
| 1 | 0.8 | 1.2 | 1.0 | 1.33 |
| 2 | 0.8 | 1.3 | 0.9 | 1.53 |
| 3 | 0.9 | 1.0 | 1.1 | 1.00 |
| 4 | 0.9 | 0.9 | 1.2 | 0.86 |
| 5 | 0.5 | 1.0 | 1.5 | 1.00 |
| 6 | 0.5 | 0.9 | 1.6 | 0.86 |
| 7 | 0.6 | 0.9 | 1.5 | 0.86 |
| 8 | 0.6 | 0.8 | 1.6 | 0.73 |

First of all, referring to FIG. 5, peaks are detected at diffraction angles (2θ) of 44.441°, 51. 784°, and 76.276°, thereby all test numbers 1 to 3 having Face-Centered Cubic FCC structure may be confirmed. In FIG. 5, the diffraction angle (2θ) of 44.441° is a diffraction peak intensity for the 111 plane, the diffraction angle (2θ) of 51.784° is a diffraction peak intensity for the 200 plane, and the diffraction angle (2θ) of 76.276° is a diffraction peak 6 intensity for the 220 plane.

Referring to Table 1, it may be confirmed that among TC(111), TC(200), and TC(220), TC(200) is the greatest for test numbers 1 and 2, and among the TC(111), TC(200), and TC(220), TC(220) is the greatest for test numbers 3 to 8. Referring to FIG. 6 and FIG. 7 illustrating TC values in a graph, it may be confirmed that for test numbers 5 to 8, TC(220) is significantly greater than TC(111) and TC(200), and test numbers 3 and 4 also have TC values in a different form from test numbers 1 and 2.

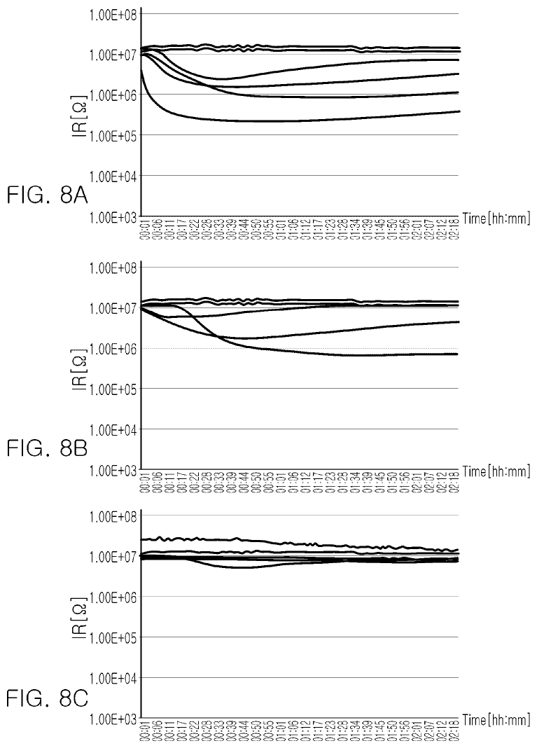

In order to verify the hydrogen diffusion suppression effect, insulation resistance was measured for test number 3, which had the greatest TC(200) value of 1.0 among the test numbers 3 to 8, and for test numbers 1 and 2, in which TC(200) had the greatest value among TC(111), TC(200), and TC(220), and then illustrated in FIG. 8. Ten sample chips were prepared for each test number, and after hydrogen charging, an insulation resistance IR was measured for more than 2 hours under conditions of temperature 105° C. and voltage 10V. The hydrogen charging was performed by mounting the chip on a substrate and then performing it to electrolytic decomposition at 60 mA for 1 hour in a 0.01 M NaOH solution, using the chip itself as the cathode.

Referring to FIG. 8a, which illustrates the insulation resistance graph for test number 3, it may be confirmed that a decrease in insulation resistance occurred in four sample chips, and the number of sample chips in which the insulation resistance IR decreased to 1/10 or less of the initial value was also two, confirming that the insulation resistance was relatively low.

Referring to FIG. 8b, which illustrates a graph for test number 1, it may be confirmed that a decrease in insulation resistance occurred in two sample chips, and the number of sample chips in which the insulation resistance IR decreased to 1/10 or less of the initial value was 1. It may be interpreted that the hydrogen diffusion suppression effect may be increased by twice or more compared to Test No. 3.

Referring to FIG. 8c, which illustrates a graph for test number 2, it may be confirmed that there is almost no decrease in insulation resistance in all sample chips, and it may be interpreted that the hydrogen diffusion suppression effect is remarkably excellent.

Although the embodiments of the present disclosure have been described in detail above, the present disclosure is not limited by the above-described embodiments and the accompanying drawings, and is intended to be limited by the appended claims. Therefore, various forms of substitution, modifications, and change will be possible by those skilled in the art within the scope of the technical spirit of the present disclosure described in the claims, which also falls within the scope of the present disclosure.

In addition, the expression ‘one embodiment’ used in the present disclosure does not mean the same embodiment, and is provided to emphasize and describe different unique characteristics. However, one embodiment presented above is not excluded from being implemented in combination with features of another embodiment. For example, even if a matter described in one specific embodiment is not described in another embodiment, it can be understood as a description related to another embodiment, unless there is a description contradicting or contradicting the matter in the other embodiment.

Terms used in this disclosure are only used to describe one embodiment, and are not intended to limit the disclosure. In this case, singular expressions include plural expressions unless the context clearly indicates otherwise.

While the embodiments have been illustrated and described above, it will be configured as apparent to those skilled in the art that modifications and variations could be made without departing from the scope of the present disclosure as defined by the appended claims.

1. A multilayer electronic component comprising:
a body including a dielectric layer and an internal electrode; and
an external electrode disposed on the body;
wherein the external electrode includes a Ni plating layer, and
wherein the Ni plating layer has a Texture Coefficient TC such that TC(200) is highest among TC(111), TC(200), and TC(220).

2. The multilayer electronic component of claim 1, wherein TC(111), TC(200) and TC(220) satisfy,
$$TC ( 111 ) = \{ I ( 111 ) / {I}_{0} ( 111 ) \} / [ 1 / 3 * \{ I ( 111 ) / {I}_{0} ( 111 ) + I ( 200 ) / {I}_{0} ( 200 ) + I ( 220 ) / {I}_{0} ( 220 ) \} ] ,$$
$$TC ( 200 ) = \{ I ( 200 ) / {I}_{0} ( 200 ) \} / [ 1 / 3 * \{ I ( 111 ) / {I}_{0} ( 111 ) + I ( 200 ) / {I}_{0} ( 200 ) + I ( 220 ) / {I}_{0} ( 220 ) \} ] ,$$
$$and$$
$$TC ( 220 ) = \{ I ( 220 ) / {I}_{0} ( 220 ) \} / [ 1 / 3 * \{ I ( 111 ) / {I}_{0} ( 111 ) + I ( 200 ) / {I}_{0} ( 200 ) + I ( 220 ) / {I}_{0} ( 220 ) \} ] ,$$
wherein I(111), I(200), and I(220) respectively refer to diffraction peak intensities of plane (111), plane (200) and plane (220) obtained from XRD analysis data of the Ni plating layer,
wherein the I₀(111), I₀(200) and I₀(220) respectively refer to the diffraction peak intensities of plane (111), plane (200) and plane (220) of standard Ni powder provided by International Centre for Diffraction Data ICDD.

3. The multilayer electronic component of claim 1, wherein the TC(200) is 1.2 or greater.

4. The multilayer electronic component of claim 1, wherein the TC(220) is 1.0 or less.

5. The multilayer electronic component of claim 1, wherein the TC(111) is 0.5 or more compared to the TC(220).

6. The multilayer electronic component of claim 1, when (200) Factor=TC(200)/[{TC(111)+TC(220)}/2] is defined,
wherein the Ni plating layer has a (200) Factor exceeding 1.0.

7. The multilayer electronic component of claim 6, wherein the Ni plating layer has (200) Factor of 1.3 or greater.

8. The multilayer electronic component of claim 6, wherein the Ni plating layer has (200) Factor of 1.5 or greater.

9. The multilayer electronic component of claim 1, wherein the Ni plating layer has a Face-Centered Cubic FCC structure.

10. The multilayer electronic component of claim 1, wherein the Ni plating layer has an atomic percentage of Ni of 95 at % or greater.

11. The multilayer electronic component of claim 1, wherein the multilayer electronic component has a maximum length of 1.1 mm or less and a maximum width of 0.55 mm or less,
wherein the TC 200 is 1.3 or greater.

12. The multilayer electronic component of claim 1, wherein the multilayer electronic component has a maximum length of 1.1 mm or less, a maximum width of 0.55 mm or less,
$$when ( 200 ) Factor = TC ( 200 ) / [ \{ TC ( 111 ) + TC ( 220 ) \} / 2 ] is defined ,$$
wherein the Ni plating layer has a (200) Factor of 1.5 or greater.

13. The multilayer electronic component of claim 1, wherein the multilayer electronic component has a maximum length of 1.44 mm or greater and a maximum width of 0.72 mm or greater.

14. The multilayer electronic component of claim 1, wherein the external electrode is connected to the internal electrode and further includes an electrode layer disposed under the Ni plating layer and an additional plating layer disposed on the Ni plating layer.

15. The multilayer electronic component of claim 1, wherein the Ni plating layer is disposed to be in contact with the body and is in direct contact with the internal electrode.

16. The multilayer electronic component of claim 15, wherein the external electrode further includes an electrode layer disposed on the Ni plating layer.

17. The multilayer electronic component of claim 16, wherein the external electrode further includes an additional Ni plating layer disposed on the electrode layer.

18. A multilayer electronic component comprising:
external electrodes including at least one layer of polycrystalline nickel (Ni) having a Texture Coefficient TC such that TC(200) is greater than TC(111) and TC(220),
wherein TC quantifies a preferred orientation of crystallites within a polycrystalline material, with TC of 1.0 signifying ideal random orientation.

19. The multilayer electronic component of claim 18, wherein TC(200) is greater than or equal to 1.2 and both TC(111) and TC(220) are less than or equal to 1.0.

20. The multilayer electronic component of claim 18, further comprising a body on which the external electrodes are disposed, the body including internal electrodes with a dielectric layer interposed therebetween.

21. The multilayer electronic component of claim 20, wherein one among the at least one polycrystalline nickel layers directly contacts the internal electrodes.

22. The multilayer electronic component of claim 18, wherein crystallites of the polycrystalline nickel have a face centered cubic (FCC) structure.

23. The multilayer electronic component of claim 18, wherein the polycrystalline nickel has (200) Factor of greater than 1.0,
$$wherein ( 200 ) Factor = TC ( 200 ) / [ \{ TC ( 111 ) + TC ( 220 ) \} / 2 ] .$$

24. A multilayer electronic component comprising:
external electrodes including at least one layer of polycrystalline nickel (Ni) having a TC(200) of greater than or equal to 1.2, TC(220) of 1.0 or less and TC(111) of less than or equal to 0.5,
wherein TC is texture coefficient and quantifies a preferred orientation of crystallites within a polycrystalline material.

25. The multilayer electronic component of claim 24, wherein crystallites of the polycrystalline nickel have a face centered cubic (FCC) structure.

26. The multilayer electronic component of claim 24, wherein the polycrystalline nickel has (200) Factor of greater than 1.0,
$$wherein ( 200 ) Factor = TC ( 200 ) / [ \{ TC ( 111 ) + TC ( 220 ) \} / 2 ] .$$
